(19) United States
(12) Patent Application Publication
(10) Pub. No.: US 2004/0121730 A1
(43) Pub. Date: Jun. 24, 2004

(54) Transmission scheme for multi-carrier MIMO systems

(76) Inventors: Tamer Kadous, San Diego, CA (US); Avneesh Agrawal, San Diego, CA (US); Rajiv Vijayan, San Diego, CA (US)

Correspondence Address: Qualcomm Incorporated, Patents Department, 5775 Morehouse Drive, San Diego, CA, 92121-1714, US

(21) Appl. No.: 10/619,703

(22) Filed: Dec. 8, 2003

Related U.S. Application Data
(60) Provisional application No. 60/419,319, filed on Oct. 16, 2002.
(60) Provisional application No. 60/456,031, filed on Mar. 17, 2003.

(51) Int. Cl. H04B 7/185

(52) U.S. Cl. 455/13.3; 455/562.1

(57) ABSTRACT

A “power adaptive circular” (PAC) transmission scheme that can support both spatial multiplexing and transmit diversity for multi-carrier MIMO systems and has a number of desirable characteristics, including the ability to: transmit a variable number of symbol streams, provide transmit diversity for each transmitted symbol stream, support coded interference estimation technique at a receiver, and use power efficiently. In one method, at least one stream of symbols is received for transmission on a plurality of subbands and from a plurality of antennas. The at least one stream of symbols is multiplexed such that (1) the symbols in each stream are transmitted from the plurality of antennas (e.g., diagonally across the subbands and antennas) and (2) the at least one stream starts in the same subband. A stream of multiplexed symbols is formed for each antenna and further processed, and may be transmitted at full power available for the antenna.

### CROSS-REFERENCE TO RELATED APPLICATION

This application claims the benefit of U.S. Provisional Patent Application Serial No. 60/419,319, filed Oct. 16, 2002, and U.S. Provisional Application Serial No. 60/456,031 filed Mar. 17, 2003, which are incorporated herein by reference in their entirety.

### BACKGROUND

I. Field

The present invention relates generally to data communication, and more specifically to a transmission scheme for multi-carrier multiple-input multiple-output (MIMO) communication systems.

II. Background

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min {N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A multi-carrier MIMO system employs multiple carriers for data transmission. These multiple carriers may be provided by orthogonal frequency division multiplexing (OFDM) or some other construct. OFDM effectively partitions the overall system bandwidth into a number of (N_{F}) orthogonal subbands, which are also referred to as tones, frequency bins, and frequency subchannels. With OFDM, each subband is associated with a respective carrier upon which data may be modulated. For a MIMO system that utilizes OFDM (i.e., a MIMO-OFDM system), the MIMO channel for each of the N_{F} subbands may be decomposed into N_{S} independent channels, resulting in a total of N_{S}N_{F} independent channels.

In a wireless communication system, data to be transmitted is initially processed (e.g., coded and modulated) to form a stream of symbols. The symbol stream is then upconverted to radio frequency (RF) to generate an RF modulated signal that is more suitable for transmission over a wireless channel. For a MIMO system, up to N_{T}RF modulated signals may be generated and transmitted in parallel from the N_{T} transmit antennas. The N_{T} transmitted signals may reach the N_{R} receive antennas via a number of propagation paths and may experience different effective channels due to different effects of fading and multipath. Moreover, for a MIMO-OFDM system, the N_{F} subbands of each transmitted signal may also experience different effective channels. Consequently, the N_{T} transmitted signals may be associated with different complex channel gains and received signal-to-noise ratios (SNRs) that can vary across the N_{F} subbands.

Spatial multiplexing may be used to transmit multiple symbol streams in parallel from the N_{T} transmit antennas. Several transmission schemes for spatial multiplexing are described in detail below. To attain high throughput, it is desirable to transmit as many symbol streams in parallel as possible. However, the number of symbol streams that may be transmitted in parallel and the rates that may be used for these symbol streams are typically dependent on the channel condition.

Transmit diversity may be used to transmit a single symbol stream from the N_{T} transmit antennas. Transmit diversity may be used if greater reliability for the symbol stream is desired or if the channel condition is so poor that it is better to use all of the available transmit power for a single symbol stream. Various transmission schemes for transmit diversity are available including (1) a “space-time diversity” scheme described by S. M. Alamouti in a paper entitled “A Simple Transmit Diversity Technique for Wireless Communications,” EEEE JSAC, Oct. 1998, and (2) a “delay diversity” scheme described by B. Raghothaman et al. in a paper entitled “Performance of Closed Loop Transmit Diversity with Feedback Delay,” Thirty-Fourth Asilomar Conference on Signals, Systems and Computers, 2000. Diversity for a single symbol stream is provided by the use of N_{T} transmit antennas (as well as N_{R} receive antennas) for the symbol stream.

To achieve high performance, a MIMO-OFDM system may be designed to support one or more transmission schemes for spatial multiplexing and one or more transmission schemes for transmit diversity. For such a MIMO-OFDM system, in any given time interval, a specific transmission scheme may be selected for use depending on the channel condition and the desired result (e.g., higher throughput or greater reliability). However, conventional transmission schemes for spatial multiplexing are quite different from conventional transmission schemes for transmit diversity. Thus, the complexity of the transmitter and receiver in the system may be greatly increased if they are required to support multiple transmission schemes, for spatial multiplexing and transmit diversity, which are quite different in design.

There is therefore a need in the art for a transmission scheme that can “gracefully” support both spatial multiplexing and transmit diversity for multi-carrier MIMO systems (e.g., MIMO-OFDM systems).

### SUMMARY

A “power adaptive circular” (PAC) transmission scheme that can support both spatial multiplexing and transmit diversity for multi-carrier MIMO systems is provided herein. The PAC transmission scheme has a number of desirable characteristics, including the ability to: (1) transmit a variable number of symbol streams, thus making it suitable for use in rate adaptive systems, (2) provide transmit diversity for each transmitted symbol stream, (3) support the use of a coded interference estimation technique at the receiver (described below) without any inherent inefficiency, (4) allow the full power available for each transmit antenna to be used for data transmission regardless of the number of transmitted symbol streams, thus making it power efficient, and (5) operate in low and high SNR environments.

In an embodiment, a method is provided for transmitting symbols in a multi-carrier MIMO system. In accordance with the method, at least one stream of symbols is received for transmission on a plurality of subbands and from a plurality of antennas. The at least one stream of symbols is multiplexed such that (1) the symbols in each stream are transmitted from the plurality of antennas (e.g., diagonally across the subbands and the antennas) and (2) the at least one stream starts in the same subband. A stream of multiplexed symbols is formed for each antenna and further processed, and may then be transmitted at full power available for the antenna.

Various aspects and embodiments of the invention are described in further detail below.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 shows a flow diagram for a successive interference cancellation (SIC) receiver processing technique;

FIG. 2A shows a symbol transmission based on a “vertical” transmission scheme;

FIGS. 2B and 2C show two symbol transmissions based on a “diagonal” transmission scheme;

FIGS. 3A through 3D show four symbol transmissions based on the PAC transmission scheme;

FIG. 4 shows a block diagram of a transmitter system and a receiver system;

FIG. 5 shows a block diagram of a transmitter unit within the transmitter system; and

FIG. 6 shows a block diagram of an RX spatial/data processor within the receiver system and which implements the SIC technique.

### DETAILED DESCRIPTION

A transmission scheme that supports both spatial multiplexing and transmit diversity for multi-carrier MIMO systems is provided herein. This transmission schemes may be used in various types of multi-carrier MIMO systems employing multiple carriers for data transmission.

For clarity, this transmission scheme is described specifically for a MIMO-OFDM system.

For a MIMO-OFDM system, the MIMO channel formed by the N_{T} transmit and N_{R} receive antennas for each of the N_{F} subbands may be decomposed into N_{S} independent channels, with N_{S}≦min {N_{T}, N_{R}}. The number of independent channels for each subband is determined by the number of eigenmodes for the MIMO channel for that subband, which in turn is dependent on a channel response matrix H(k) that describes the response between the N_{T} transmit and N_{R} receive antennas for that subband. For simplicity, the description below assumes the following: N_{T}≦N_{R}, the channel response matrix H(k) is full rank (i.e., N_{S}=N_{T}≦N_{R}), and all N_{F} subbands are used for data transmission (i.e., there are no guard subbands). With these assumptions, for each symbol period, N_{T}N_{F} symbols may be transmitted in parallel from the N_{T} transmit antennas on the N_{F} subbands.

The model for a MIMO-OFDM system may be expressed as:

y(k)=H(k)x(k)+n(k), for k∈K, Eq (1)

where x(k) is an {N_{T}×1} “transmit” vector with N_{T} entries for N_{T} symbols transmitted from the N_{T} transmit antennas on subband k;

y(k) is an {N_{R}×1} “receive” vector with N_{R} entries for N_{R} symbols received on the N_{R}receive antennas on subband k;

H(k) is the {N_{R}×N_{T}} channel response matrix for subband k;

n(k) is a vector of additive white Gaussian noise (AWGN); and

K is the set of subbands used for data transmission (e.g., K={1 . . . N_{F}}).

The vector n(k) is assumed to have zero mean and a covariance matrix of Λₙ=σ²I, where I is the identity matrix with ones along the diagonal and zeros everywhere else, and σ² is the variance of the noise.

Due to scattering in the propagation environment, the N_{T} symbol streams transmitted from the N_{T} transmit antennas interfere with each other at the receiver. A symbol stream transmitted from a given transmit antenna may be received by all N_{R} receive antennas at different amplitudes and phases. Each received signal may then include a component of each of the N_{T} transmitted symbol streams. The N_{R} received signals would collectively include all N_{T} transmitted symbol streams that are dispersed among the N_{R} received signals.

At the receiver, various processing techniques may be used to process the N_{R} received signals to detect the N_{T} transmitted symbol streams. These receiver processing techniques may be grouped into two primary categories:

Spatial and space-time receiver processing techniques, which are also referred to as equalization techniques; and

Successive nulling/equalization and interference cancellation receiver processing technique, which is also referred to as “successive interference cancellation” (SIC) technique.

In general, the equalization techniques attempt to separate out the transmitted symbol streams at the receiver. Each transmitted symbol stream may be “detected” by (1) combining the various components of this transmitted symbol stream, which are included in the N_{R} received signals, based on an estimate of the channel response and (2) removing the interference due to the other transmitted symbol streams. The equalization techniques attempt to either (1) decorrelate the individual transmitted symbol streams such that there is no interference from the other transmitted symbol streams or (2) maximize the SNR of each detected symbol stream in the presence of noise and interference from the other symbol streams. Each detected symbol stream is an estimate of a corresponding transmitted symbol stream and is further processed (e.g., demodulated, deinterleaved, and decoded) to recover the data for the symbol stream.

The SIC technique processes the N_{R} received symbol streams to successively recover one transmitted symbol stream at a time. As each transmitted symbol stream is recovered, the interference it causes to the remaining not yet recovered symbol streams is estimated and canceled from the received symbol streams. The “modified” symbol streams are then processed to recover another transmitted symbol stream. If the interference due to each recovered symbol stream can be accurately estimated and canceled, which requires error-free or low-error recovery of the symbol stream, then the later recovered symbol streams experience less interference and may be able to achieve higher SNRs. The SIC technique generally outperforms the equalization techniques.

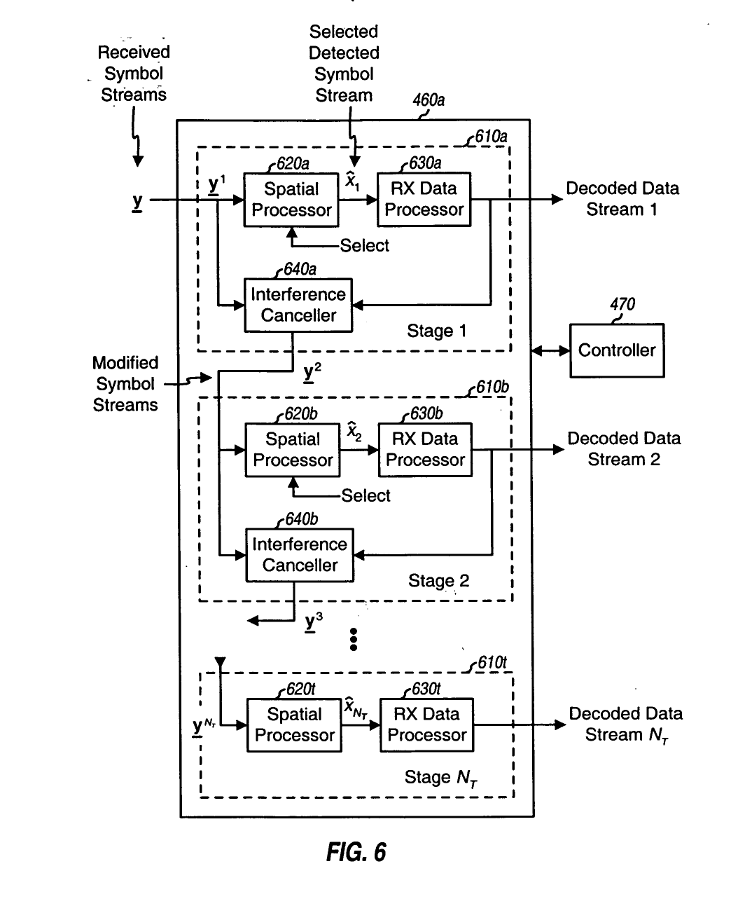

For simplicity, the following description for the SIC technique assumes that one symbol stream is transmitted from each transmit antenna. Also, the following terminology is used for the description (see also FIG. 6):

“transmitted” symbol streams—the symbol streams transmitted from the N_{T} transmit antennas;

“received” symbol streams—the inputs to a spatial processor in the first stage of a SIC receiver;

“modified” symbol streams—the inputs to the spatial processor in each subsequent stage of the SIC receiver;

“detected” symbol streams—the outputs from the spatial processor at each stage (up to N_{T}−l+1 symbol streams may be detected at stage l); and

“recovered” symbol stream—a symbol stream that is decoded at the receiver (only one detected symbol stream is recovered by each stage).

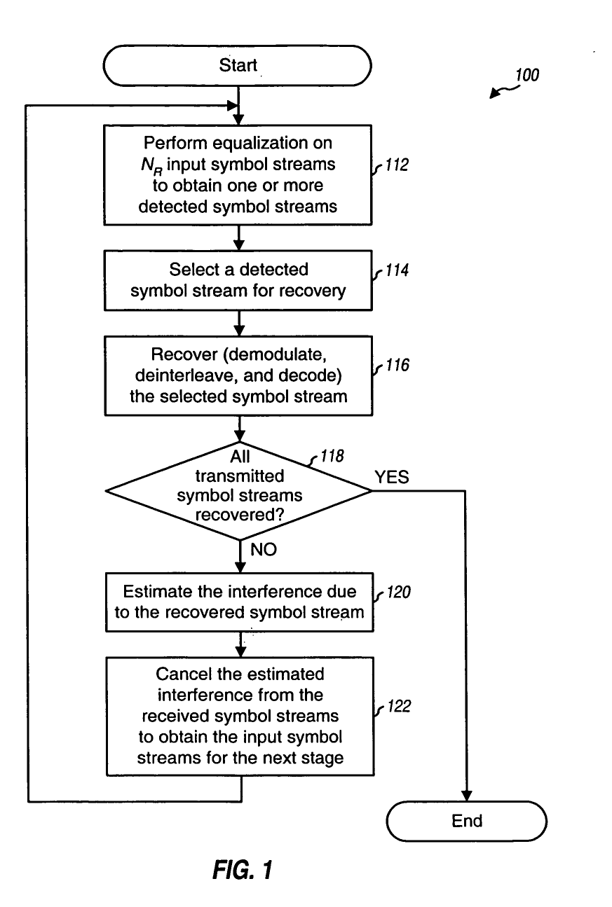

FIG. 1 shows a flow diagram of a process 100 to operate on N_{R} received symbol streams to recover N_{T} transmitted symbol streams using the SIC technique. For the first stage (l=1), the receiver performs equalization on the N_{R} received symbol streams to attempt to separate out the N_{T} transmitted symbol streams (step 112). The equalization may be performed based on a linear filter, which may be implemented as a zero-forcing (ZF) filter, a minimum mean square error (MMSE) filter, or some other type of linear filter. The ZF filter is also referred to as a channel correlation matrix inversion (CCMI) filter. Alternatively, the equalization may be performed based on a non-linear filter, which may be implemented as an MMSE linear equalizer (MMSE-LE), a decision feedback equalizer (DFE), or some other type of non-linear filter. The ZF and MMSE filters, MMSE-LE, and DFE are described in detail in U.S. patent application Ser. No. 09/993,087, entitled “Multiple-Access Multiple-Input Multiple-Output (MIMO) Communication System,” filed Nov. 6, 2001, assigned to the assignee of the present application and incorporated herein by reference. The equalization is performed independently for each of the N_{F} subbands.

For the first stage, the equalization can provide N_{T} detected symbol streams that are estimates of the N_{T} transmitted symbol streams. One of the detected symbol streams is then selected for recovery (step 114). If the identity of the transmitted symbol stream to be recovered is known a priori, then the equalization may be performed such that only the desired detected symbol stream is obtained. In any case, the selected detected symbol stream is further processed to obtain decoded data, which is an estimate of the transmitted data for the symbol stream just recovered (step 116).

A determination is then made whether or not all transmitted symbol streams have been recovered (step 118). If the answer is yes, then the receiver processing terminates. Otherwise, the interference due to the just-recovered symbol stream on each of the N_{R} received symbol streams is estimated using a particular interference estimation technique (step 120).

For an uncoded interference estimation technique, the interference due to the just-recovered symbol stream may be estimated by convolving the selected detected symbol stream with a set of channel response vectors hⱼ(k), for k∈K, to obtain N_{R} interference components due to the just-recovered symbol stream. The convolving is performed on a per-subband basis such that the detected symbol for the k-th subband is convolved with the vector hⱼ(k) for that subband. The vector hⱼ(k) is the j-th column of the channel response matrix H(k) and corresponds to the j-th transmit antenna used to transmit this detected symbol. The vector hⱼ(k) includes N_{R} elements for the channel response between the j-th transmit antenna and the N_{R} receive antennas for the k-th subband.

For a coded interference estimation technique, the interference due to the just-recovered symbol stream may be estimated by first re-encoding the decoded data, interleaving the re-encoded data, and symbol mapping the interleaved data (using the same coding, interleaving, and modulation schemes used at the transmitter unit for this symbol stream). The result is a “remodulated” symbol stream that is a more accurate estimate of the transmitted symbol stream just recovered. The remodulated symbol stream is then convolved with the set of channel response vectors hⱼ(k), for k∈K, to obtain N_{R} interference components due to the just-recovered symbol stream.

In any case, the N_{R} interference components are then subtracted from the N_{R} received symbol streams to obtain N_{R} modified symbol streams (step 122). These modified symbol streams represent the streams that would have been received if the just-recovered symbol stream had not been transmitted, assuming that the interference cancellation was effectively performed.

Steps 112 through 116 are repeated on the N_{R} modified symbol streams to recover another transmitted symbol stream. Steps 120 and 122 are performed if there is another transmitted symbol stream to be recovered. The process continues until all transmitted symbol streams are recovered. For each subsequent stage, the input symbol streams for that stage are the N_{R} modified symbol streams from the preceding stage.

The SIC technique is described in further detail in the aforementioned U.S. patent application Ser. No. 09/993,087 and in U.S. patent application Ser. No. 10/087,503, entitled “Data Transmission with Non-Uniform Distribution of Data Rates for a Multiple-Input Multiple-Output (MIMO) System,” filed Mar. 1, 2002, assigned to the assignee of the present application and incorporated herein by reference.

Various transmission schemes may be used to transmit symbols on the N_{F} subbands of the N_{T} transmit antennas. Each transmission scheme provides different performance for the transmitted symbol streams. For simplicity, the following description assumes that four transmit antennas (i.e., N_{T}=4) and 16 subbands (i.e., N_{F}=16) are used for data transmission.

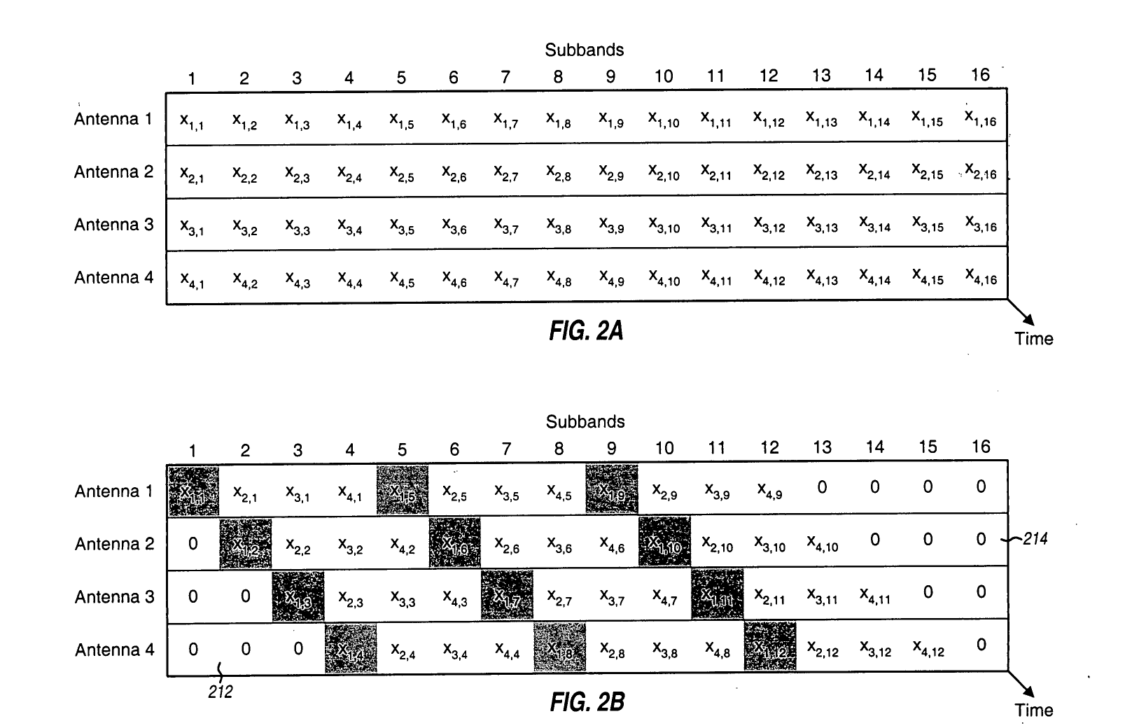

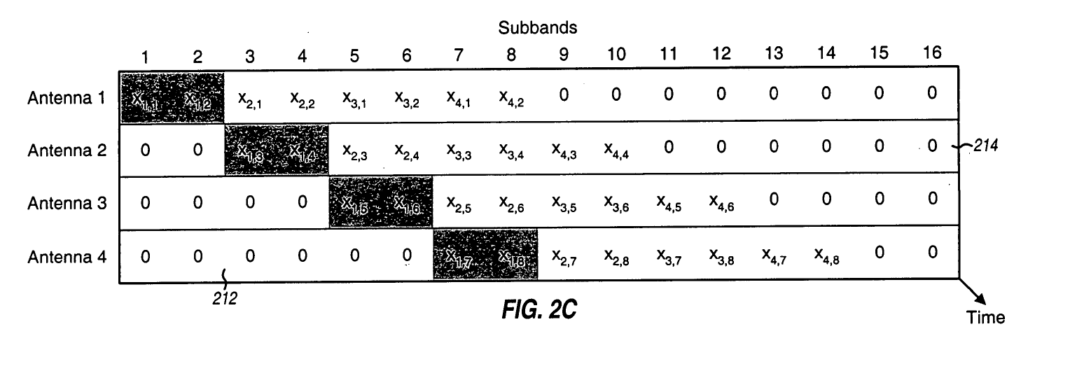

FIG. 2A shows a “vertical” transmission scheme whereby one symbol stream is transmitted from each transmit antenna. This scheme is also referred to as a “horizontal” transmission scheme since each code word extends horizontally across the subbands for one antenna. In FIG. 2A, x_{m,n} denotes the n-th symbol in the m-th symbol stream. For the vertical transmission scheme, the symbols in each symbol stream are transmitted on the N_{F} subbands of the associated transmit antenna. In particular, the symbols for the first symbol stream {x₁} are transmitted in sequential order across the N_{F} subbands of transmit antenna 1, the symbols for the second symbol stream {x₂} are transmitted in sequential order across the N_{F} subbands of transmit antenna 2, and so on. The four symbol streams are transmitted in parallel from the four transmit antennas.

At the receiver, the four transmitted symbol streams may be recovered by using the SIC technique described in FIG. 1. To recover the first transmitted symbol stream, equalization is performed on the N_{R} received symbol streams to provide four detected symbol streams. One detected symbol stream is then recovered. The interference due to the recovered symbol stream is estimated and subtracted from the N_{R} received symbol streams, and the N_{R} modified symbol streams are then processed to recover the next transmitted symbol stream.

For the vertical transmission scheme, the performance achieved by each symbol stream is dependent on the order in which the symbol streams are recovered. The first recovered symbol stream experiences interference from the other three symbol streams and has a diversity order of (N_{R}−N_{T}+1). If the interference due to the first recovered symbol stream is accurately estimated and canceled, then the second recovered symbol stream experiences interference from only two symbol streams (and not the first recovered symbol stream, since it has been canceled) and has a diversity order of (N_{R}−N_{T}+2). Each subsequently recovered symbol stream thus experiences successively less interference and is able to achieve higher SNR. It can also be seen that the diversity order increases for each later-recovered symbol stream.

The vertical transmission scheme suffers from a major shortcoming—the lack of transmit diversity. As shown in FIG. 2A, each symbol stream is transmitted from only one transmit antenna. This can be highly undesirable in a fading environment.

FIG. 2B shows a “diagonal” transmission scheme whereby each symbol stream is transmitted diagonally from all N_{T} transmit antennas. Conventionally, the diagonal transmission scheme transmits N_{T} symbol streams in a manner to achieve similar average performance for all of the symbol streams. This requires each frame to be padded with a number of zeros at the start of the frame (in triangle 212) and also at the end of the frame (in triangle 214). A frame corresponds to a group of symbols that is transmitted on all N_{F} subbands of all N_{T} transmit antennas in one symbol period.

As shown in FIG. 2B, for the first symbol stream {x₁}, the symbol x_{1,1} is transmitted on subband 1 of transmit antenna 1, the symbol x_{1,2} is transmitted on subband 2 of antenna 2, the symbol x_{1,3} is transmitted on subband 3 of antenna 3, the symbol x_{1,4} is transmitted on subband 4 of antenna 4, the symbol x_{1,5} is transmitted on subband 5 of antenna 1 (wrapped around), and so on. The other three symbol streams are transmitted diagonally in similar manner, as shown in FIG. 2B.

At the receiver, the four transmitted symbol streams may be recovered using the SIC technique. To recover the first transmitted symbol stream {x₁}, equalization is performed on the N_{R} received symbols for subband 1 to obtain one detected symbol \hat{x}_{1,1}, which is an estimate of the symbol x_{1,1} transmitted on subband 1. The detected symbol \hat{x}_{1,1} attains the maximum diversity order of N_{R} since it is the only symbol transmitted on this subband. Equalization is next performed on the N_{R} received symbols for subband 2 to obtain the detected symbol \hat{x}_{1,2}, which is an estimate of the symbol x_{1,2} transmitted on this subband. The symbol x_{2,1} is an interference that is nulled out when the symbol x_{1,2} is detected. The detected symbol \hat{x}_{1,2} attains a diversity order of N_{R}−1. Equalization is then performed for subband 3 to obtain the detected symbol \hat{x}_{1,3}, which is an estimate of the symbol x_{1,3} transmitted on this subband. The symbols x_{2,2} and x_{3,1} are interference that is nulled out when the symbol x_{1,3} is detected. The symbol \hat{x}_{1,3} attains a diversity order of N_{R}−2. The equalization for subband 4 provides the detected symbol \hat{x}_{1,4}, which is an estimate of the symbol x_{1,4} and attains a diversity order of N_{R}−3.

To recover the second transmitted symbol stream {x₂}, the interference due to the detected symbol \hat{x}_{1,2} is estimated and canceled from the N_{R} received symbols for subband 2.

Equalization is then performed on the N_{R} modified symbols for subband 2 to provide one detected symbol \hat{x}_{2,1} (since the symbol \hat{x}_{1,2} has been canceled), which is an estimate of the symbol x_{2,1} transmitted on subband 2 for the second symbol stream. The detected symbol \hat{x}_{2,1} thus attains the maximum diversity order of N_{R}, which is the same as that of the detected symbol \hat{x}_{1,1} for the first symbol stream. Similarly, the interference due to the detected symbol \hat{x}_{1,3} is estimated and canceled from the N_{R} received symbols for subband 3. Equalization is then performed on the N_{R} modified symbols for subband 3 to provide two detected symbol \hat{x}_{2,2} and \hat{x}_{3,1} (since the symbol \hat{x}_{1,3} has been canceled). The detected symbol \hat{x}_{2,2} thus attains a diversity order of N_{R}−1, which is the same as that of the detected symbol \hat{x}_{1,2} for the first symbol stream. Similarly, the detected symbols \hat{x}_{2,3} and \hat{x}_{2,4} for the second symbol stream, which respectively attain diversity orders of N_{R}−2 and N_{R}−3, are obtained for subbands 4 and 5.

From the above description for the diagonal transmission scheme, by padding zeros at the start and end of each frame, the diversity order achieved for each symbol stream cycles through N_{R}, N_{R}−1, N_{R}−2, and N_{R}−3 then back to N_{R}, and so on. The diagonal transmission scheme provides two main advantages: (1) similar average performance for all transmitted symbol streams and (2) transmit diversity for each symbol stream via transmission from all N_{T} transmit antennas.

However, the diagonal transmission scheme suffers from a major shortcoming inefficiency due to the need to pad zeros at the start and end of each frame in order to attain the performance intended for this scheme. This inefficiency is exacerbated if the coded interference estimation technique is used, as described below.

In order for the SIC technique to provide the desired performance, it is assumed that the interference due to each recovered symbol stream can be accurately estimated and canceled from the received symbol streams. The accuracy of the interference estimate is dependent on the ability to correctly detect/recover each symbol stream to be canceled. Conventionally, the uncoded interference estimation technique is used for both the vertical and diagonal transmission schemes.

For the uncoded interference estimation technique, the interference estimate is derived based on the detected symbols, which are typically distorted due to noise and other artifacts in the wireless channel. Errors in the detected symbols lead directly to errors in the interference estimate, which acts as additional noise for each subsequently recovered symbol stream. This phenomenon is referred to as error propagation (EP). If the error propagation is sufficiently bad, then the SIC technique can fail completely.

The coded interference estimation technique uses the error correction capability of the channel coding to limit error propagation. Each recovered symbol stream is decoded based on the channel coding to provide decoded data, which is normally an accurate estimate of the transmitted data since errors (up to a limit) can be corrected by the decoding process. The decoded data is then re-encoded and symbol-mapped to provide a more accurate estimate of the transmitted symbols, which are then used to derive the interference estimate. The coding and decoding are normally performed on blocks of data. Each data block is often referred to as a codeword. The use of channel coding mitigates the deleterious effects of error propagation but can result in greater inefficiency for the diagonal transmission scheme, as described below.

FIG. 2C shows a symbol transmission using the diagonal transmission scheme and in such a manner to allow for the use of the coded interference estimation technique at the receiver.

For simplicity, a codeword spans 8 symbols in the following description. Each codeword can span only one diagonal of the transmit antennas and cannot wrap around for the reason described below.

For the first codeword of the first symbol stream, the symbols x_{1,1} and x_{1,2} are respectively transmitted on subbands 1 and 2 of transmit antenna 1, the symbols x_{1,3} and x_{1,4} are respectively transmitted on subbands 3 and 4 of transmit antenna 2, the symbols x_{1,5} and x_{1,6} are respectively transmitted on subbands 5 and 6 of transmit antenna 3, and the symbols x_{1,7} and x_{1,8} are respectively transmitted on subbands 7 and 8 of transmit antenna 4. For each of the other three symbol streams, the symbols for each codeword are transmitted along a respective diagonal band of two subbands along transmit antennas 1, 2, 3, and 4, as shown in FIG. 2B. Although not shown in FIG. 2C for simplicity, another codeword may be transmitted in another diagonal band after (i.e., to the right of) the last diagonal band shown in FIG. 2B.

At the receiver, the four transmitted symbol streams may be recovered using the SIC technique. In particular, to recover the first codeword of the first transmitted symbol stream, equalization is performed on the N_{R} received symbols for each of subbands 1 and 2 to obtain two detected symbols \hat{x}_{1,1} and \hat{x}_{1,2}, both of which attain the maximum diversity order of N_{R}. Equalization is next performed on the N_{R} received symbols for each of subbands 3 and 4 to obtain two pairs of detected symbols (\hat{x}_{1,3} and \hat{x}_{2,1}) and (\hat{x}_{1,4} and \hat{x}_{2,2}) for these subbands. The detected symbols \hat{x}_{1,3} and \hat{x}_{1,4} both attain diversity order of N_{R}−1. The equalization for each of subbands 5 and 6 provides two detected symbols \hat{x}_{1,5} and \hat{x}_{1,6}, both of which attain diversity order of N_{R}−2. The equalization for each of subbands 7 and 8 provides two detected symbols \hat{x}_{1,7} and \hat{x}_{1,8} both of which attain diversity order of N_{R}−3. The eight detected symbols \hat{x}_{1,1} through \hat{x}_{1,8} for the first codeword of the first symbol stream can now be recovered.

To recover the first codeword of the second transmitted symbol stream, the interference due to the detected symbols \hat{x}_{1,3} and \hat{x}_{1,4} is estimated and canceled from the N_{R} received symbols for subbands 3 and 4, respectively. Equalization is then performed on the N_{R} modified symbols for each of subbands 3 and 4 to provide detected symbols \hat{x}_{2,1} and \hat{x}_{2,2} (since the symbols \hat{x}_{1,3} and \hat{x}_{1,4} have been canceled). The processing for the second symbol stream proceeds in similar manner as described above.

As can be seen from FIG. 2C, each codeword needs to be transmitted in one diagonal and cannot wrap around. This is because wrapped-around symbols will not allow different streams to achieve equal diversity orders. Zeros would need to be padded at the start of each frame, as shown in FIG. 2C, with the number of zeros being dependent on the length of the codeword. Longer codewords are often preferable since they are generally more efficient and may also provide better coding performance. However, longer codewords also require more zero padding for each frame, which would then lead to greater inefficiency.

Depending on the length of the codeword, the number of subbands, and other factors, it can be shown that the overhead due to the padded zeros can be quite large (e.g., as much as 50 percent) in order to support the use of the coded interference estimation technique at the receiver. Such a large overhead can more than offset the advantages provided by the diagonal transmission scheme and makes its use infeasible for some MIMO-OFDM systems.

A power adaptive circular (PAC) transmission scheme that can support both spatial multiplexing and transmit diversity is provided herein. The PAC transmission scheme provides many of the key benefits of the vertical and diagonal transmission schemes and further supports the use of the coded interference estimation technique at the receiver, without any inherent efficiency due to zero padding, as described below.

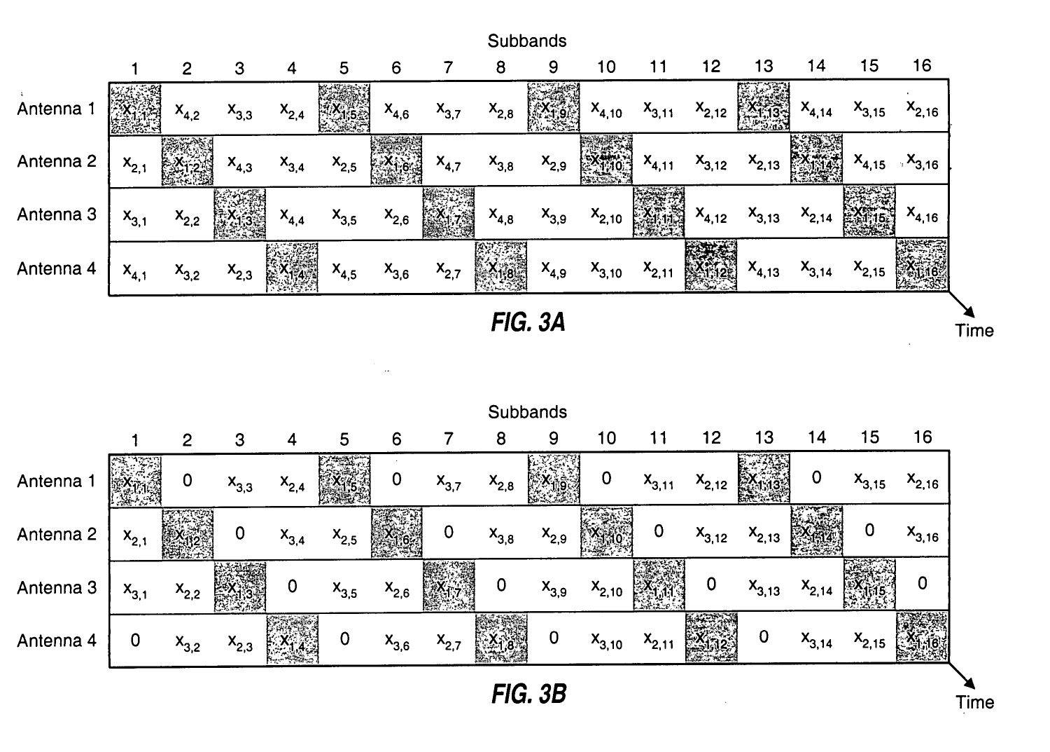

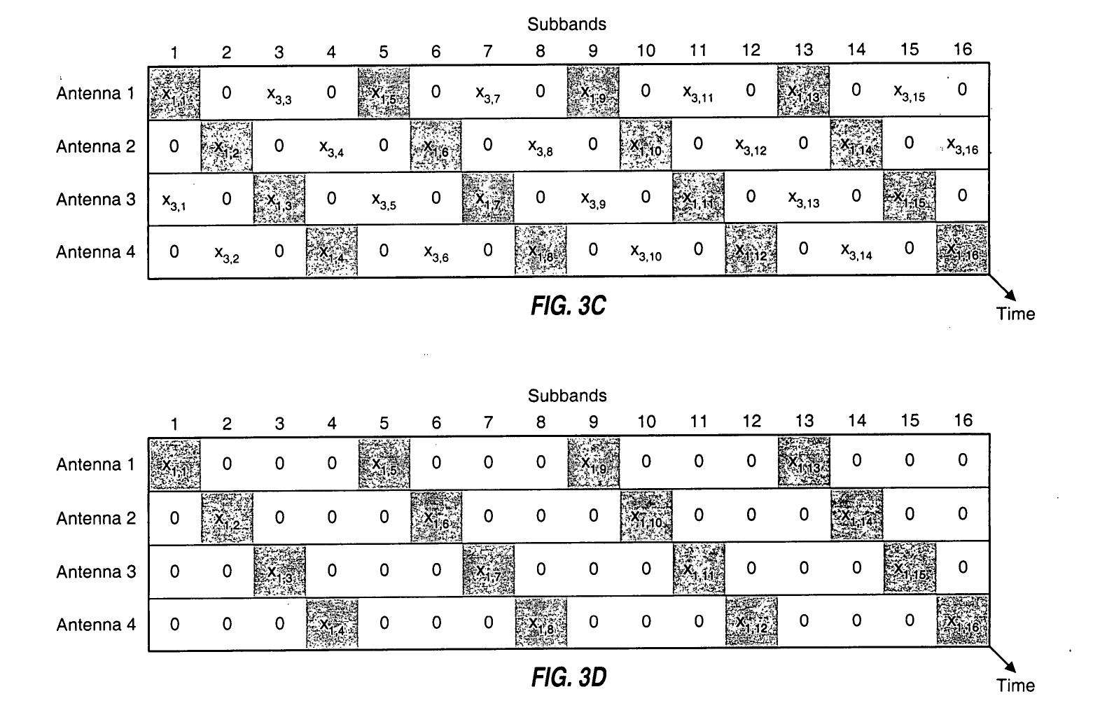

FIG. 3A shows the PAC transmission scheme for a spatial multiplexing mode whereby N_{T} symbol streams are transmitted diagonally from all N_{T} transmit antennas. For the first symbol stream {x₁}, the first four symbols x_{1,1}, x_{1,2}, x_{1,3}, and x_{1,4} are transmitted on subbands 1, 2, 3, and 4, respectively, of transmit antennas 1, 2, 3, and 4, respectively. The next four symbols x_{1,5}, x_{1,6}, x_{1,7}, and x_{1,8}, wrap around and are transmitted on subbands 5, 6, 7, and 8, respectively, of transmit antennas 1, 2, 3, and 4, respectively. For the second symbol stream {X₂}, the first four symbols x_{2,1}, x_{2,2}, x_{2,3}, and x_{2,4} are transmitted on subbands 1, 2, 3, and 4, respectively, of transmit antennas 2, 3, 4, and 1, respectively. The next four symbols x_{2,5}, x_{2,6}, x_{2,7}, and x_{2,8} wrap around and are transmitted on subbands 5, 6, 7, and 8, respectively, of transmit antennas 2, 3, 4, and 1, respectively. Similarly, each of the other two symbol streams is transmitted across the N_{T} transmit antennas and wraps around as many times as needed. As shown in FIG. 3A, the four symbol streams start in the same subband (subband 1) and no zeros need to be padded at the start or the end of the frame.

At the receiver, the four transmitted symbol streams may be recovered using the SIC technique. Any one of the four transmitted symbol streams may be selected for recovery first.

For example, the first transmitted symbol stream {x₁} may be detected and recovered in similar manner as that described above for FIG. 2A. The interference due to the first symbol stream may be estimated using the coded interference estimation technique and subtracted from the N_{R} received symbol streams. The N_{R} modified symbol streams are then processed to recover the next transmitted symbol stream.

In general, the four transmitted symbol streams may be recovered in any order. For example, the first symbol stream may be recovered first, followed by the second symbol stream, then the third symbol stream, and finally the fourth symbol stream. The symbol streams may also be recovered in some other order.

For the PAC transmission scheme, the performance achieved by each symbol stream is dependent on the order in which the symbol streams are recovered, similar to the vertical transmission scheme. The first recovered symbol stream experiences interference from three other symbol streams and has a diversity order of (N_{R}−N_{T}+1). The second transmitted symbol stream experiences interference from two other symbol streams and has a diversity order of (N_{R}−N_{T}+2). Each subsequently recovered symbol stream thus experiences successively less interference and is able to achieve higher SNR.

The same amount of transmit power may be used for each of the four transmitted symbol streams. The full power Pₐₙₜ available for each transmit antenna may be distributed among the four symbol streams such that each symbol stream receives Pₐₙₜ/4 from each transmit antenna and Pₐₙₜ for all four transmit antennas. In this case, different rates may be used for the four symbol streams, where the rates may be determined based in part on the order in which the symbol streams are recovered. The use of non-uniform rates for the symbol streams is described in the aforementioned U.S. patent application Ser. No. 10/087,503 and in U.S. patent application Ser. No. 10/176,567, entitled “Rate Control for Multi-Channel Communication, Systems,’ filed Jun. 20, 2002, assigned to the assignee of the present application and incorporated herein by reference.

Alternatively, different amounts of transmit power may be used for the four transmitted, symbol streams. For example, the four symbol streams may be allocated transmit powers of P₁ through P₄, which may be selected such that the four detected symbol streams achieve approximately the same SNRs at the receiver. This may then allow the same rate to be used for all transmitted symbol streams. The determination of transmit powers to achieve the same SNRs for the symbol streams is also described in the aforementioned U.S. patent application Ser. No. 10/087,503.

Conventionally, the vertical and diagonal transmission schemes are both designed to transmit fixed rate symbol streams (i.e., all symbol streams have the same rate). Moreover, these two transmission schemes require high SNRs for proper system operation. This, is because these transmission schemes were intended for use with the uncoded interference estimation technique, which requires high SNRs to limit the deleterious effects of error propagation.

The PAC transmission scheme is well suited for rate adaptive MIMO systems and supports the transmission or a variable number of symbol streams, from one to N_{T}. In certain instances, it is desirable to transmit fewer than N_{T}symbol streams (e.g., for certain channel conditions and/or to achieve greater reliability).

FIG. 3B shows the transmission of three symbol streams diagonally from all four transmit antennas using the PAC transmission scheme. The three symbol substreams {x₁}, {x₂}, and {X₃} are transmitted in the same manner as that described above for FIG. 3A. Signal values of zero are transmitted on the subbands/antennas that would have been used to transmit the fourth symbol stream. As shown in FIG. 3B, the three symbol streams start in the same subband (subband 1) and no zeros need to be padded at the start or the end of the frame for these symbol streams. To completely utilize the full power Pₐₙₜ available for each transmit antenna, the transmit power for each of the three symbol streams may be scaled by a factor of 4/3 higher than the transmit power used for each of the four symbol streams in FIG. 3A.

FIG. 3C shows the transmission of two symbol streams diagonally from all four transmit antennas using the PAC transmission scheme. The two symbol substreams {x₁} and {x₂} are transmitted in the same manner as that described above for FIG. 3A. Signal values of zero are transmitted in the subbands/antennas that would have been used to transmit the third and fourth symbol streams. As shown in FIG. 3C, the two symbol streams start in the same subband (subband 1) and no zeros need to be padded at the start or the end of the frame for these symbol streams. Again, to completely utilize the full power available for each transmit antenna, the transmit power for each of the two symbol streams may be scaled by a factor of 2 higher than the transmit power used for each of the four symbol streams in FIG. 3A.

FIG. 3D shows the transmission of a single symbol stream diagonally from all four transmit antennas using the PAC transmission scheme. The symbol substream {x₁} is transmitted in the same manner as that described above for FIG. 3A. Signal values of zero are transmitted on the subbands/antennas that would have been used to transmit the second, third, and fourth symbol streams. The full powers available for the four transmit antennas may all be used for this single symbol stream such that its power is scaled by a factor of 4 higher than the transmit power used for each of the four symbol streams in FIG. 3A.

FIGS. 3A through 3D show the transmission of the symbol streams diagonally across all N_{T} transmit antennas and across all N_{F} subbands. The symbol streams may also be transmitted across the transmit antennas using some other multiplexing patterns (instead of diagonally), and this is within the scope of the invention.

The PAC transmission scheme has the following key features:

Can transmit a variable number of symbol streams (from one to N_{T}) while retaining key characteristics, making it suitable for use in rate adaptive systems;

Provide transmit diversity for each transmitted symbol stream;

Support the use of the coded interference estimation technique at the receiver without any inherent inefficiency (zero padding is not needed);

Allow the full power available for each transmit antenna to be used for transmission regardless of the number of transmitted symbol stream, thus making it power efficient; and

Can operate in low and high SNR environments.

Each of these features is described in detail below.

As shown in FIGS. 3A through 3D, the PAC transmission scheme can gracefully support both spatial multiplexing (to transmit multiple symbol streams) and transmit diversity (to transmit a single symbol stream). The processing at the transmitter and receiver is essentially the same regardless of the number of transmitted symbol streams since the basic structure of the PAC transmission scheme does not change with the number of transmitted symbol streams. Additional stages of the SIC receiver (or additional iterations by the hardware) may be needed for more transmitted symbol streams, but the basic processing remains essentially the same. The processing at both the transmitter and receiver may thus be simplified by the use of the PAC transmission scheme for both spatial multiplexing and transmit diversity.

The PAC transmission scheme provides transmit diversity for each transmitted symbol stream. As shown in FIGS. 3A through 3D, each symbol stream may be transmitted from all N_{T} transmit antennas, regardless of the number of transmitted symbol streams. Moreover, each symbol stream may also be transmitted on all N_{F} subbands to obtain frequency diversity.

The PAC transmission scheme supports the use of the coded interference estimation technique at the receiver without incurring inefficiency due to zero padding. As shown in FIG. 3A, four symbol streams can be transmitted from four transmit antennas without any zero padding at the start or the end of the frame. Moreover, there are no specific requirements on the length of the codewords or the transmission of each codeword, as is the case for the diagonal transmission scheme shown in FIG. 2C. For the PAC transmission scheme, each codeword may wrap around as many times as needed and may even span multiple frames. The length of the codeword may affect memory and processing requirements at the transmitter and receiver, but does not affect the efficiency of the symbol transmission.

The PAC transmission scheme is power efficient and allows the full power available for each transmit antenna to be used for data transmission regardless of the number of transmitted symbol streams. If the channel is degraded and supports fewer than N_{T} symbol streams, then the full power available for each transmit antenna may be redistributed among the fewer number of transmitted symbol streams. For example, if only three symbol streams are transmitted as shown in FIG. 3B, then the transmit power for each symbol stream may be increased by a factor of 4/3, from Pₐₙₜ to 4Pₐₙₜ/3. If only one symbol stream is transmitted as shown in FIG. 3D, then all of the power available for all transmit antennas may be used for this single symbol stream. The use of full power for symbol transmission can result in higher SNR at the receiver, which can improve reliability and/or support higher rates.

The redistribution of transmit power, when fewer than N_{T} symbol streams are transmitted, does not affect power spectral density (PSD). This is because the total power per subband for all transmit antennas remains the same regardless of the number of transmitted symbol streams. For example, if three symbol streams are transmitted as shown in FIG. 3B, then three symbols are transmitted from three transmit antennas for each subband. Thus, even though these three symbols are transmitted at 4/3 times the transmit power as in FIG. 3A, the total power per subband for all four transmit antennas remains the same as for FIG. 3A. This feature may be important if the system is operating in a frequency band with a per-MHz constraint and a total power constraint.

The PAC transmission scheme is also suitable for use in low and high SNR environments.

This is supported in part by the ability to transmit different numbers of symbol streams depending on the channel conditions. Moreover, the use of the coded interference estimation technique allows the system to be operated in low SNR environment (which is not possible for the conventional vertical and diagonal transmission schemes that use the uncoded interference estimation technique).

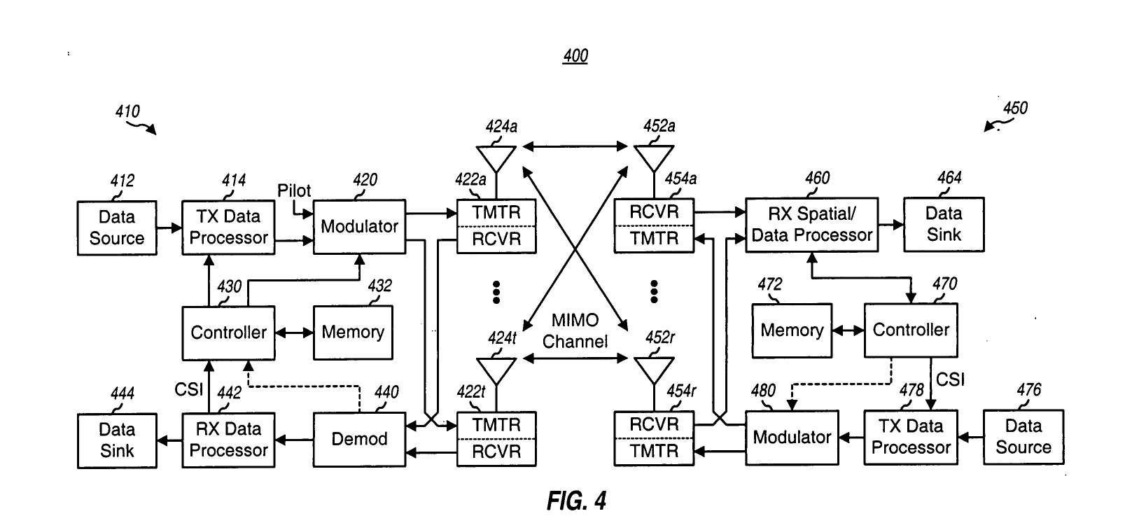

FIG. 4 shows a block diagram of an embodiment of a transmitter system 410 and a receiver system 450 in a MIMO-OFDM system 400. At transmitter system 410, data for one or multiple streams is provided by a data source 412, coded by a transmit (TX) data processor 414, and- modulated by a modulator 420 to provide modulation symbols. The data rate, coding, and modulation for each stream may be determined by controls provided by a controller 430. The modulation symbols for all streams and pilot symbols are then multiplexed and further processed to provide N_{T} OFDM symbol streams. These N_{T} OFDM symbol streams are further processed by N_{T} transmitters (TMTR) 422a through 422t to provide N_{T}RF modulated signals, which are then transmitted from N_{T} antennas 424a through 424t.

At receiver system 450, the N_{T} transmitted signals are received by N_{R} antennas 452a through 452r. Each receiver (RCVR) 454 processes a received signal from an associated antenna 452 to provide a corresponding received symbol stream. A receive (RX) spatial/data processor 460 then processes the N_{R} received symbol streams from N_{R} receivers 454 to provide N_{T} detected symbol streams, and further processes each detected symbol stream to obtain decoded data for the stream.

RX spatial/data processor 460 may also derive an estimate of the channel response between the N_{T} transmit and N_{R} receive antennas (e.g., based on the pilot symbols) for each subband used for data transmission. The channel response estimate may be used to perform equalization at the receiver. RX spatial/data processor 460 may further estimate the SNRs of the detected symbol streams. Controller 470 may provide channel state information (CSI) regarding the MIMO channel and/or the received symbol streams (e.g., the received SNRs or rates for the symbol streams). The CSI is then processed by a TX data processor 478, modulated by a modulator 480, conditioned by transmitters 454a through 454r, and sent back to transmitter system 410.

At transmitter system 410, the modulated signals from receiver system 450 are received by antennas 424, conditioned by receivers 422, demodulated by a demodulator 440, and processed by an RX data processor 442 to recover the CSI sent by the receiver system. The CSI is then provided to controller 430 and may be used to (1) determine the number of symbol streams to transmit, (2) determine the rate and coding and modulation scheme to use for each symbol stream, and (3) generate various controls for TX data processor 414 and modulator 420.

Controllers 430 and 470 direct the operation at the transmitter and receiver systems, respectively. Memory units 432 and 472 provide storage for program codes and data used by controllers 430 and 470, respectively.

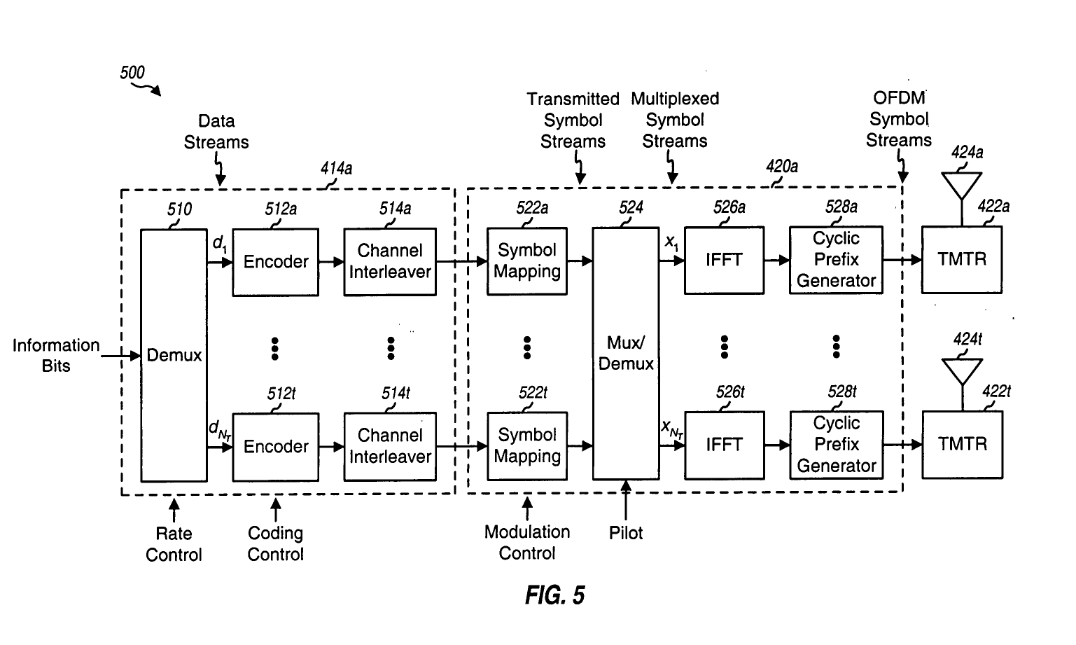

FIG. 5 shows a block diagram of a transmitter unit 500, which is an embodiment of the transmitter portion of transmitter system 410 in FIG. 4. In this embodiment, TX data processor 414a includes a demultiplexer 510, N_{T} encoders 512a through 512t, and N_{T} channel interleavers 514a through 514t (i.e., one set of encoder and channel interleaver for each stream). Demultiplexer 510 demultiplexes the data into N_{D} data streams, where N_{D} may be any integer from one to N_{T}. Each data stream is coded and interleaved by a respective set of encoder 512 and channel interleaver 514. The N_{D} coded data streams are then provided to modulator 420a.

In this embodiment, modulator 420a includes N_{T} symbol mapping elements 522a through 522t, a multiplexer/demultiplexer (Mux/Demux) 524, and N_{T} OFDM modulators. Each OFDM modulator includes an inverse fast Fourier transform (IFFT) unit 526 and a cyclic prefix generator 528. Each of the N_{D} coded data streams is symbol mapped by a respective symbol mapping element 522 to provide a respective stream of modulation symbols, which is referred to as a transmitted symbol stream. Mux/Demux 524 then performs the multiplexing to transmit the modulation symbols for the N_{D} streams on the proper subbands and transmit antennas. For example, the multiplexing may be performed as shown in FIGS. 3A through 3D or based on some other multiplexing scheme. Mux/Demux 524 provides N_{T} multiplexed symbol streams to the N_{T} OFDM modulators.

Within each OFDM modulator, for each symbol period, N_{F} symbols for the N_{F} subbands are transformed by IFFT unit 526 to obtain a corresponding time-domain “transformed” symbol that includes N_{F}, samples. To combat frequency selective fading, cyclic prefix generator 528 repeats a portion of each transformed symbol to obtain a corresponding OFDM symbol. A stream of OFDM symbols is formed for each transmit antenna and further processed by an associated transmitter 422 to obtain an RF modulated signal. N_{T}RF modulated signals are generated and transmitted in parallel from the N_{T} transmit antennas.

FIG. 6 shows a block diagram of an RX spatial/data processor 460a that implements the SIC technique and is an embodiment of RX spatial/data processor 460 in FIG. 4. RX spatial/data processor 460a includes a number of successive (i.e., cascaded) receiver processing stages 610a through 610t, one stage for each of the transmitted symbol streams to be recovered. Each receiver processing stage 610 (except for the last stage 610t) includes a spatial processor 620, an RX data processor 630, and an interference canceller 640. The last stage 610t includes only spatial processor 620t and RX data processor 630t.

For the first stage 610a, spatial processor 620a performs equalization on the N_{R} received symbol streams (denoted as a vector y¹) to provide up to N_{T} detected symbol streams that are estimates of the transmitted symbol streams. Spatial processor 620a performs the inverse of the subband/antenna multiplexing performed by Mux/Demux 524. One detected symbol stream \hat{x}₁ is selected for recovery, and RX data processor 630a processes this detected symbol stream to provide decoded data for the stream. Spatial processor 620a may further provide an estimate of the channel response, which is used to perform equalization-for all stages.

For the first stage 610a, interference canceller 640a receives and processes (e.g., encodes, interleaves, and symbol maps) the decoded data for the symbol stream just recovered to provide a remodulated symbol stream \check{x}₁, which is further processed to obtain the interference components due to the just-recovered symbol stream. The interference components are then subtracted from the first stage's input symbol streams y¹ to obtain N_{R} modified symbol streams (denoted as a vector y²), which are then provided to the next stage.

For each of the second through last stages 610b through 610t, the spatial processor for that stage receives and processes the N_{R} modified symbol streams from the interference canceller in the preceding stage to obtain one or more detected symbol streams for that stage. For each stage, one detected symbol stream is selected and processed by the RX data processor to provide the decoded data for that stream. For each of the second through second-to-last stages, the interference canceller in that stage receives the N_{R} modified symbol streams from the interference canceller in the preceding stage and the decoded data from the RX data processor within the same stage, derives the interference components due to the symbol stream recovered by that stage, and provides N_{R} modified symbol streams for the next stage.

Although the SIC technique may provide improved performance, the PAC transmission scheme may also be used in conjunction with a receiver that does not use the SIC technique (i.e., no interference cancellation).

The PAC transmission scheme described herein may be implemented by various means at the transmitter and receiver. For example, the processing for the PAC transmission scheme may be implemented in hardware, software, or a combination thereof. For a hardware implementation, the processing units at the transmitter and receiver may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination,. thereof.

For a software implementation, the processing for the PAC transmission scheme may be implemented with modules (e.g., procedures, functions, and so on) that perform the functions described herein. The software codes may be stored in a memory unit (e.g., memory units 432 and 472 in FIG. 4) and executed by a processor (e.g., controllers 430 and 470). Each memory unit may be implemented within the processor or external to the processor, in which case it can be communicatively coupled to the processor via various means as is known in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of processing symbols for transmission in a multi-carrier multiple-input multiple-output (MIMO) communication system, comprising:
receiving at least one stream of symbols for transmission on a plurality of subbands and from a plurality of antennas;
multiplexing the at least one stream of symbols such that the symbols in each of the at least one stream are transmitted from the plurality of antennas and such that the at least one stream starts in the same subband; and
forming a stream of multiplexed symbols for each of the plurality of antennas.

2. The method of claim 1, wherein the symbols in each of the at least one stream are transmitted diagonally across the plurality of subbands and the plurality of antennas.

3. The method of claim 1, wherein N_{T} streams of symbols are multiplexed,to form N_{T} streams of multiplexed symbols for N_{T} antennas, where N_{T} is an integer greater than one.

4. The method of claim 1, wherein one stream of symbols is multiplexed to form N_{T} streams of multiplexed symbols for N_{T} antennas, where N_{T} is an integer greater than one.

5. The method of claim 1, wherein N_{D} streams of symbols are multiplexed to form N_{T} streams of multiplexed symbols for N_{T} antennas, where N_{T} is an integer greater than one and N_{D} is an integer less than or equal to N_{T}.

6. The method of claim 1, wherein the stream of multiplexed symbols for each antenna is transmitted at full power available for the antenna.

7. The method of claim 1, wherein each of the at least one stream is transmitted at N_{T}/N_{D} times full power for one antenna in the plurality of antennas, where N_{D} is the number of streams of symbols and N_{T} is the number of antennas.

8. The method of claim 1, wherein same amount of transmit power is used for each of the at least one stream of symbols.

9. The method of claim 1, wherein same total power is used for the plurality of antennas for each of the plurality of subbands.

10. The method of claim 1, wherein a variable number of streams of symbols is transmitted based on channel condition.

11. The method of claim 1, wherein each stream in the at least one stream is associated with a rate determined based at least in part on a received signal quality for the stream.

12. The method of claim 1, wherein each stream in the at least one stream is associated with a rate determined based at least in part on an order in which the at least one stream is recovered at a receiver.

13. The method of claim 1, wherein a codeword for a stream in the at least one stream wraps around the plurality of antennas.

14. A method of transmitting symbols in a multi-carrier multiple-input multiple-output (MIMO) communication system, comprising:
receiving at least one stream of symbols for transmission on a plurality of subbands and from a plurality of antennas;
multiplexing the at least one stream of symbols such that the symbols in each of the at least one stream are transmitted diagonally across the plurality of subbands and the plurality of antennas and such that the at least one stream starts in the same subband;
forming a stream of multiplexed symbols for each of the plurality of antennas; and
transmitting the stream of multiplexed symbols for each antenna at full power available for the antenna.

15. A transmitter apparatus in a multi-carrier multiple-input multiple-output (MIMO) communication system, comprising:
means for receiving at least one stream of symbols for transmission on a plurality of subbands and from a plurality of antennas;
means for multiplexing the at least one stream of symbols such that the symbols in each of the at least one stream are transmitted from the plurality of antennas and such that the at least one stream starts in the same subband; and
means for forming a stream of multiplexed symbols for each of the plurality of antennas.

16. The transmitter apparatus of claim 15, further comprising:
means for transmitting the stream of multiplexed symbols for each antenna at full power available for the antenna.

17. A transmitter unit in a multi-carrier multiple-input multiple-output (MIMO) communication system, comprising:
at least one symbol mapping element operative to code data to provide at least one stream of symbols for transmission on a plurality of subbands and from a plurality of antennas; and
a multiplexer operative to multiplex the at least one stream of symbols such that the symbols in each of the at least one stream are transmitted from the plurality of antennas and such that the at least one stream starts in the same subband, and to form a stream of multiplexed symbols for each of the plurality of antennas.

18. The transmitter unit of claim 17, further comprising:
a plurality of transmitters associated with the plurality of antennas, each transmitter operative to transmit a respective stream of multiplexed symbols at full power available for an associated antenna.

19. A method of processing symbols received in a multi-carrier multiple-input multiple-output (MIMO) communication system, comprising:
obtaining a plurality of streams of received symbols for a plurality of receive antennas, wherein each of the plurality of streams of received symbols includes symbols received on a plurality of subbands of an associated receive antenna, and wherein the plurality of streams of received symbols include at least one stream of transmitted symbols having been multiplexed such that the transmitted symbols in each of the at least one stream are sent from the plurality of transmit antennas and such that the at least one stream starts in the same subband; and
processing the plurality of streams of received symbols to recover the at least one stream of transmitted symbols.

20. The method of claim 19, wherein the processing includes
performing equalization on the plurality of streams of received symbols to detect the at least one stream of transmitted symbols, and
recovering each detected stream of transmitted symbols.

21. The method of claim 19, wherein the processing is based on a successive interference cancellation (SIC) technique.

22. The method of claim 19, wherein the processing includes performing equalization on the plurality of streams of received symbols to detect a first stream of transmitted symbols in the at least one stream,
recovering the detected stream of transmitted symbols,
estimating interference due to the recovered stream of transmitted symbols, and
canceling the estimated interference from the plurality of streams of received symbols to obtain a plurality of streams of modified symbols, and
wherein the performing and recovering are repeated on the plurality of streams of modified symbols to recover a second stream of transmitted symbols in the at least one stream.

23. The method of claim 22, wherein the interference is estimated based on a coded interference estimation technique.

24. The method of claim 19, further comprising:
determining a rate for each stream in the at least one stream based on an estimated received signal quality for the stream.

25. A receiver apparatus in a multi-carrier multiple-input multiple-output (MIMO) communication system, comprising:
means for obtaining a plurality of streams of received symbols for a plurality of receive antennas, wherein each of the plurality of streams of received symbols include symbols received on a plurality of subbands of an associated receive antenna, and wherein the plurality of streams of received symbols include at least one stream of transmitted symbols having been multiplexed such that the transmitted symbols in each of the at least one stream are sent from the plurality of transmit antennas and such that the at least one stream starts in the same subband; and
means for processing the plurality of streams of received symbols to recover the at least one stream of transmitted symbols.
